(19) United States
(12) Patent Application Publication
(10) Pub. No.: US 2017/0201486 A1
(43) Pub. Date: Jul. 13, 2017

(54) INFORMATION PROCESSING APPARATUS AND INFORMATION PROCESSING PROGRAM

(71) Applicant: FUJI XEROX CO., LTD., Tokyo (JP)

(72) Inventor: Yuki KANAZAWA, Yokohama-shi (JP)

(73) Assignee: FUJI XEROX CO., LTD., Tokyo (JP)

(21) Appl. No.: 15/216,194

(22) Filed: Jul. 21, 2016

(30) Foreign Application Priority Data
Jan. 13, 2016 (JP) 2016-004016

(51) Int. Cl. H04L 29/12

(52) U.S. Cl. CPC H04L 61/2076; H04L 61/2046; H04L 61/2007

(57) ABSTRACT

An information processing apparatus includes a notification unit that, in response to receiving information indicating update of a communication address from a device, when the communication address indicated to be updated overlaps with a communication address of another device, notifies a message of the update to a manager and an updating unit that, in response to receiving approval about the notification by the notification unit, updates a value of a storage unit managing the communication address of the device with the communication address of the device indicated to be updated.

### CROSS-REFERENCE TO RELATED APPLICATIONS

This application is based on and claims priority under 35 USC 119 from Japanese Patent Application No. 2016-004016 filed on Jan. 13, 2016.

### BACKGROUND

### Technical Field

The present invention relates to an information processing apparatus and an information processing program.

### SUMMARY

An aspect of the invention provides an information processing apparatus including: a notification unit that, in response to receiving information indicating update of a communication address from a device, when the communication address indicated to be updated overlaps with a communication address of another device, notifies a message of the update to a manager; and an updating unit that, in response to receiving approval about the notification by the notification unit, updates a value of a storage unit managing the communication address of the device with the communication address of the device indicated to be updated.

### BRIEF DESCRIPTION OF THE DRAWINGS

Exemplary embodiments of the present invention will be described in detail based on the following figures, wherein:

FIG. 1 is a conceptual module configuration diagram illustrating an example of a configuration of an exemplary embodiment;

FIG. 2 is an explanation diagram illustrating an example of a system configuration using the exemplary embodiment;

FIG. 3 is a flowchart illustrating an example of processes according to the exemplary embodiment;

FIG. 4 is an explanation diagram illustrating an example of a data structure of a device management information table;

FIGS. 5A and 5B are explanation diagrams illustrating examples of a data structure of a change notification information table;

FIG. 6 is an explanation diagram illustrating an example of a data structure of a change notification accumulated information table;

FIG. 7 is an explanation diagram illustrating an example of processes according to the exemplary embodiment;

FIG. 8 is an explanation diagram illustrating an example of processes according to the exemplary embodiment;

FIG. 9 is an explanation diagram illustrating an example of processes according to the exemplary embodiment; and

FIG. 10 is a block diagram illustrating an example of a hardware configuration of a computer implementing the exemplary embodiment.

### DETAILED DESCRIPTION

Hereinafter, an example of an exemplary embodiment implementing the invention will be described with reference to the drawings.

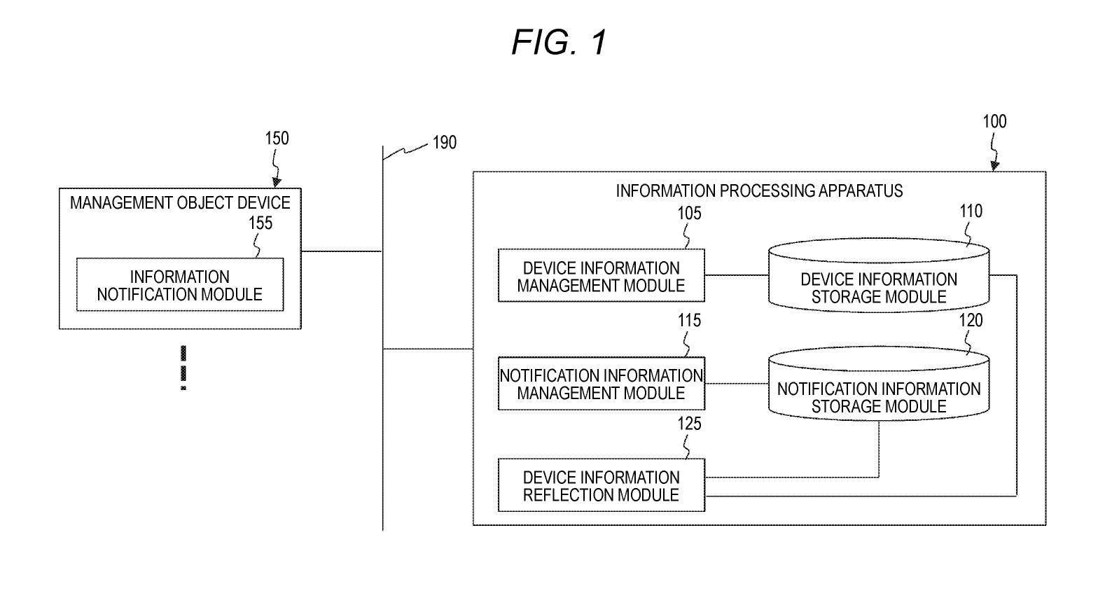

FIG. 1 is a conceptual module configuration diagram illustrating an example of a configuration of an exemplary embodiment.

In addition, a module denotes a part of software (computer program), hardware, and the like which can be generally logically separated. Accordingly, the module according to the exemplary embodiment denotes a module in a hardware configuration as well as a module in a computer program. Therefore, the description of the exemplary embodiment may be used for a computer program (a program for allowing a computer to execute each procedure, a program for allowing a computer to function as each unit, or a program for allowing a computer to implement each function), a system, and a method which are allowed to function as such a module. However, for the convenience of description, phrases “to store”, “allowed to be stored”, and equivalent phrases are used. In a case where the exemplary embodiment is a computer program, these phrases denote “to store in a storage device” or “to be controlled to store in a storage device”. In addition, the modules may be in one-to-one correspondence to functions. However, in the implementation, one module may be configured with one program, plural modules may be configured with one program, and on the contrary, one module may be configured with plural program. In addition, plural modules may be executed by one computer and one module may be executed by plural computers in a distributed or parallel environment. In addition, other modules may be included in one module. In addition, hereinafter, the term “connection” is used for the case of logical connection (data exchange, indication, reference between data, or the like) as well as physical connection. The phrase “to be defined in advance” denotes “to be defined before an object process and is used to denote “to be defined according to situation and state at that time or situation and state until now not only before the start of the process according to the exemplary embodiment but also after the start of the process according to the exemplary embodiment before the object process”. In a case where there are plural “predetermined values”, the values may be different from each other, and two or more values (furthermore, including the entire values) may be equal to each other. In addition, the phrase “in the case of A, B is performed” is used so as to denote “to determine whether or not A” and if it is determined A, B is performed”. However, a case where the determination as to whether or not A is unnecessary is excluded.

In addition, a system or a device includes a system or device configured by connecting plural computers, hardware, devices, and the like through a communication unit such as a network (including a one-to-one communication connection) and furthermore, a case where the system or device is implemented by one computer, hardware, device, or the like. The terms “device” and “system” are used as the same term. Moreover, the “system” does not include a sociological structure (society system) which is determined artificially.

In addition, in a case where plural processes are performed in every process of each module or within the module, in every process, object information is read from a storage device, and after the process, a result of the process is written in the storage device. Therefore, there is case where reading from the storage device before the process, and writing in the storage device after the process may be omitted in description. In addition, the storage device described herein may include a hard disk, a RAM (random access memory), an external storage medium, a storage device via a communication line, a register in a CPU (central processing unit), or the like.

As illustrated in the example of FIG. 1, an information processing apparatus 100 according to an exemplary embodiment is connected to plural management object devices 150 through a communication line 190.

The management object device 150 has a communication function and is a device such as a copying machine, a facsimile, a scanner, a printer, or a multifunction device (an image processing device having two or more functions of a scanner, a printer, a copying machine, and a facsimile). In addition, the management object device 150 is managed by the information processing apparatus 100. For example, in the case of a device such as the above-mentioned multifunction device, a user who is to use the device, information (specifically, capacity, folder name, and the like which can be used by the user) on a storage device (for example, a hard disk or the like) which can be used by the user, a destination list (destination of a facsimile, mail address of the user, and the like), and the like are set by the information processing apparatus 100.

The management object device 150 needs to set communication address (for example, IP address and the like) in order to have a communication function. If there is movement of installation locations between the management object devices 150, installation of a new management object device 150, or the like, in some cases, the communication address of the management object device 150 (to-be-moved management object device 150, the new management object device 150, or other management object devices 150) may be updated. The “updating” herein also includes setting of a new communication address besides changing of an existing communication address. Since the updating of the communication address is performed independently of each management object device 150 (without consideration for other management object devices 150), mismatch of the communication address occurs. For example, in some cases, the updated communication address may overlap with the communication address of another device. Hereinafter, as the communication address, an IP address is exemplified in the description.

The management object device 150 is configured to include an information notification module 155. In the case of changing communication settings of the management object device 150 (including a case where the settings are changed in advance), the information notification module 155 notifies information indicating the update of the communication address to the information processing apparatus 100 (hereinafter, also referred to as change notification information). The notification may be performed according to manipulation of a manipulator, or the notification may be one of the cases of the situation where the notification is defined in advance, for example, a case where the device is first powered on, or the like.

The change notification information includes a communication address of the management object device 150 and information (for example, a serial number or the like) for uniquely identifying the management object device 150 in the exemplary embodiment. In addition, the change notification information may include information indicating that the approval of the manager is necessary. Furthermore, the change notification information may include a before-changed communication address and a device name, an installation location, and a remark of the management object device 150 (information indicating general data of the management object device 150 or the like).

The information processing apparatus 100 is to manage the plural management object devices 150, and as illustrated in the example of FIG. 1, the information processing apparatus is configured to include a device information management module 105, a device information storage module 110, a notification information management module 115, a notification information storage module 120, and a device information reflection module 125. As the management of the management object device 150, for example, as described above, a user who is to use the management object device 150, information on a storage device which can be used by the user, a destination list, and the like are reflected on the management object device 150.

The device information management module 105 is connected to the device information storage module 110. The device information management module 105 manages device management information of the plural management object devices 150.

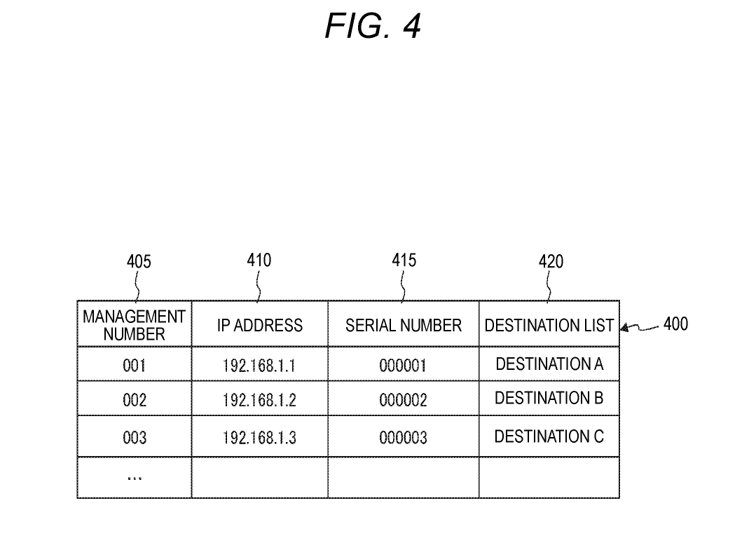

The device information storage module 110 is connected to the device information management module 105 and the device information reflection module 125. The device information storage module 110 stores device management information. For example, the device information storage module stores a device management information table 400. FIG. 4 is an explanation diagram illustrating an example of a data structure of the device management information table 400. The device management information table 400 is configured to include a management number filed 405, an IP address field 410, a serial number field 415, and destination list field 420. The management number filed 405 stores a management number as information for uniquely identifying each column (row) of the device management information table 400 according to the exemplary embodiment. The IP address field 410 stores IP addresses of the management object devices 150. The serial number field 415 stores serial numbers of the management object devices 150. The destination list field 420 stores a destination list which is to be reflected on the management object device 150.

The notification information management module 115 is connected to the notification information storage module 120. In a case where the notification information management module 115 receives the information indicating the update of the communication address from the management object device 150, when the to-be-updated communication address overlaps with the communication address of another management object device 150, the notification information management module notifies a message of the update to the manager. In addition, the notification information management module 115 manages the information received from the management object device 150.

In a case where the notification information management module 115 receives information indicating the update of the communication address from another second management object device 150 different from the management object device 150, when there is a notification by the notification information management module 115 but there is a non-updated management object device 150, the notification information management module may be allowed to notify a message of the update of the communication address of the second management object device 150 to the manager.

In addition, in a case where the information indicating that the approval of the manager is necessary is included in the information indicating the update of the communication address from the management object device 150, the notification information management module 115 may be allowed to notify a message of the update to the manager.

The notification information storage module 120 is connected to the notification information management module 115 and the device information reflection module 125. The notification information storage module 120 stores, for example, a change notification information table 500 and a change notification accumulated information table 600.

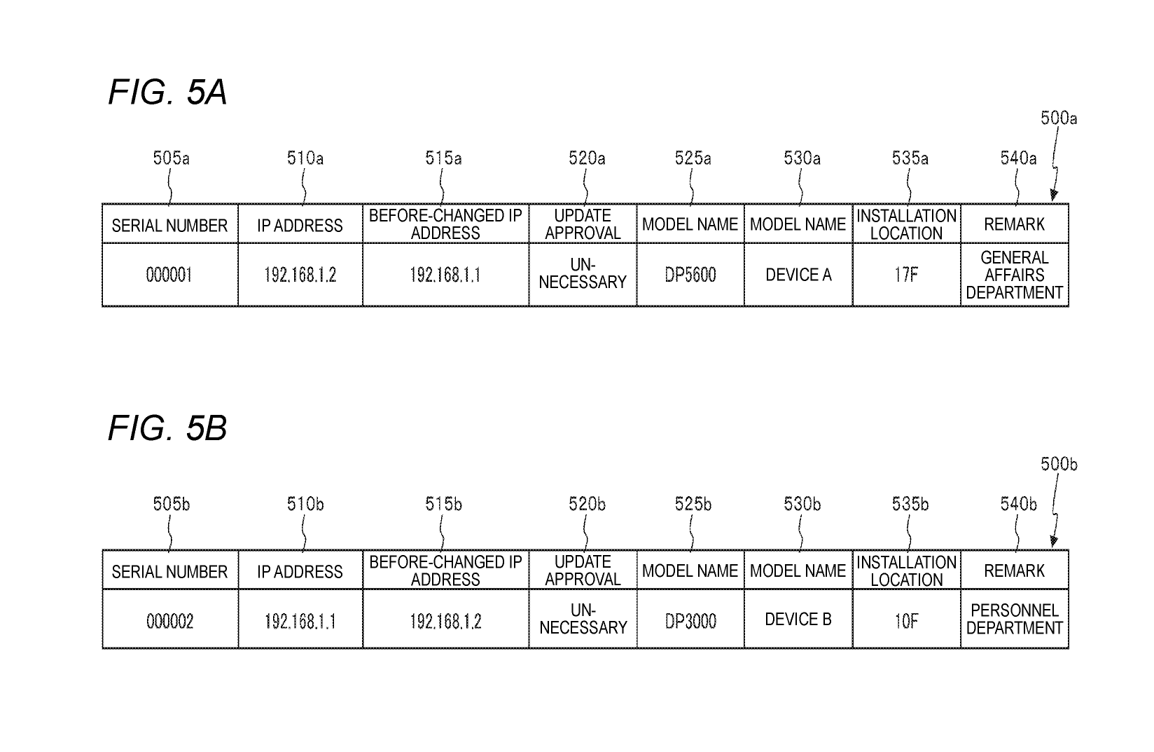

FIGS. 5A and 5B are explanation diagrams illustrating examples of a data structure of the change notification information table 500. The change notification information table 500 is information received from the management object device 150.

The change notification information table 500 is configured to include a serial number field 505, an IP address field 510, a before-changed IP address field 515, an update approval field 520, a model name field 525, a device name field 530, an installation location field 535, and a remark field 540. The serial number field 505 stores a serial number of the management object device 150. The IP address field 510 stores an IP address of the management object device 150. The before-changed IP address field 515 stores a before-changed IP address of the management object device 150. The update approval field 520 stores a flag indicating whether the update approval of the management object device 150 is necessary or unnecessary. The model name field 525 stores a model number of the management object device 150. The device name field 530 stores a device name of the management object device 150. The installation location field 535 stores an installation location of the management object device 150. The remark field 540 stores a remark of the management object device 150.

For example, a change notification information table 500a illustrated in an example of FIG. 5A is received from a management object device 150A to be stored in the notification information storage module 120, and a change notification information table 500b illustrated in an example of FIG. 5B is received from a management object device 150B to be stored in the notification information storage module 120.

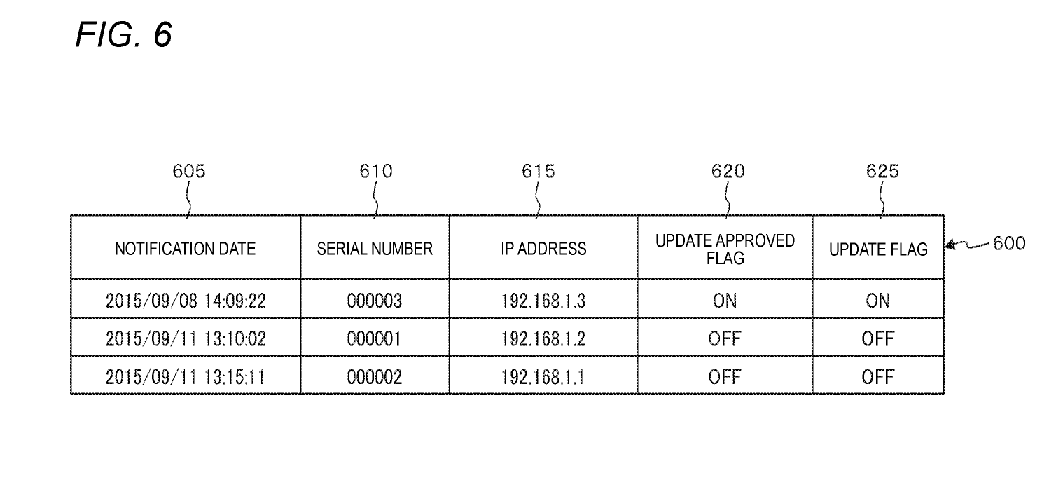

FIG. 6 is an explanation diagram illustrating an example of a data structure of the change notification accumulated information table 600. The change notification accumulated information table 600 stores a portion of the information of the change notification information table 500 received from the management object device 150 and results of the processes performed by the notification information management module 115 and the device information reflection module 125.

The change notification accumulated information table 600 is configured to include a notification date field 605, a serial number field 610, an IP address field 615, an update approved flag field 620, and an update flag field 625. The notification date field 605 stores a date (year, month, day, hour, minute, second, sub-second, or a combination thereof) when the change notification information table 500 is received from the management object device 150. The serial number field 610 stores a serial number of the management object device 150. The IP address field 615 stores an IP address of the management object device 150. The update approved flag field 620 stores a flag indicating whether or not the updating of the communication address is approved by the manager. The update flag field 625 stores a flag whether or not the updating of the communication address of the management object device 150 is performed.

The device information reflection module 125 is connected to the device information storage module 110 and the notification information storage module 120. In a case where there is approval about the notification by the notification information management module 115, the device information reflection module 125 updates the value of the notification information storage module 120 managing the communication address of the management object device 150 with the communication address of the management object device 150. Of course, the communication address is the updated communication address as well as the “to-be-updated communication address”.

In addition, in a case where the approval of the manager is unnecessary, the device information reflection module 125 updates the device management information and reflects the device management information on the management object device 150. In a case where the update approval is necessary, after the update approval is received, the device information reflection module updates the device management information and reflects the device management information on the management object device 150. If the updating of the communication address is rejected by the manager, the updating of the communication address of the management object device 150 is not performed.

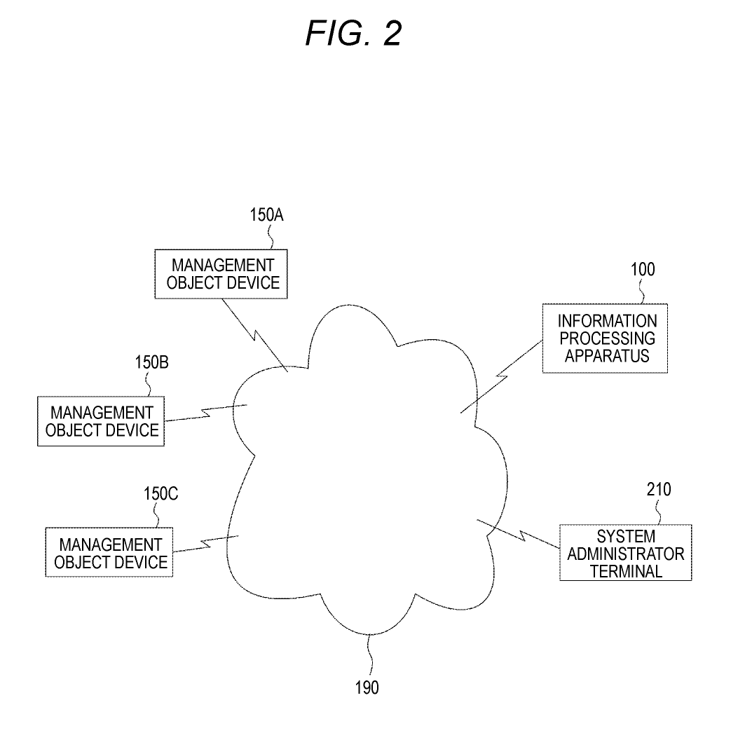

FIG. 2 is an explanation diagram illustrating an example of a system configuration using the exemplary embodiment.

The information processing apparatus 100, the management object device 150A, the management object device 150B, the management object device 150C, and the system administrator terminal 210 are connected to each other via the communication line 190. The communication line 190 may be a wireless line, a wired line, or a combination thereof, and for example, the communication line may be the Internet or an intranet as communication infrastructures. In addition, the function by the information processing apparatus 100 may be implemented by a cloud service.

In the case of newly installing the management object device 150, the case of changing the IP address of the management object device 150, or the like, the management object device 150 transmits information indicating the update of the IP address to the information processing apparatus 100. When the to-be-updated IP address overlaps with the IP address of another management object device 150, the information processing apparatus 100 notifies a message of the update to the system administrator terminal 210. In the system administrator terminal 210, approval or rejection is manipulated by the manager, and the result thereof is transmitted to the information processing apparatus 100. In the case of receiving the approval from the system administrator terminal 210, the information processing apparatus 100 performs an IP address updating process, and in the case of receiving the rejection from the system administrator terminal 210, the information processing apparatus does not perform the IP address updating process.

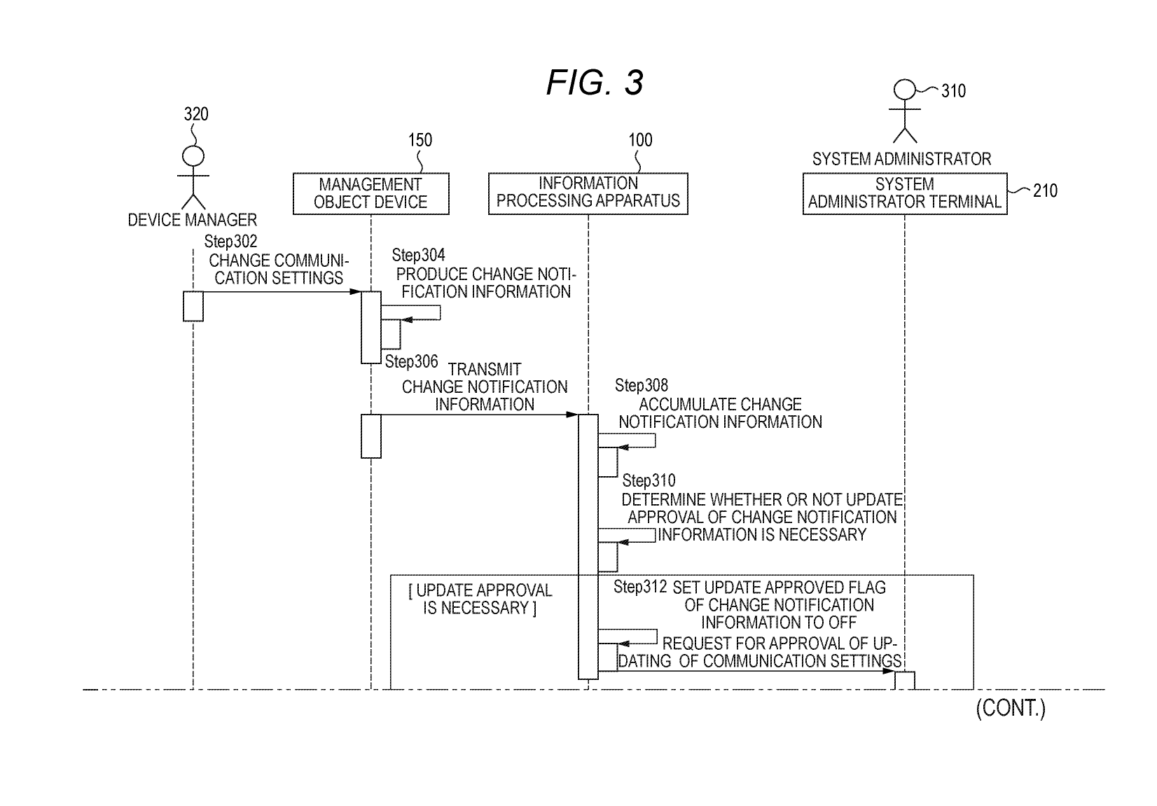

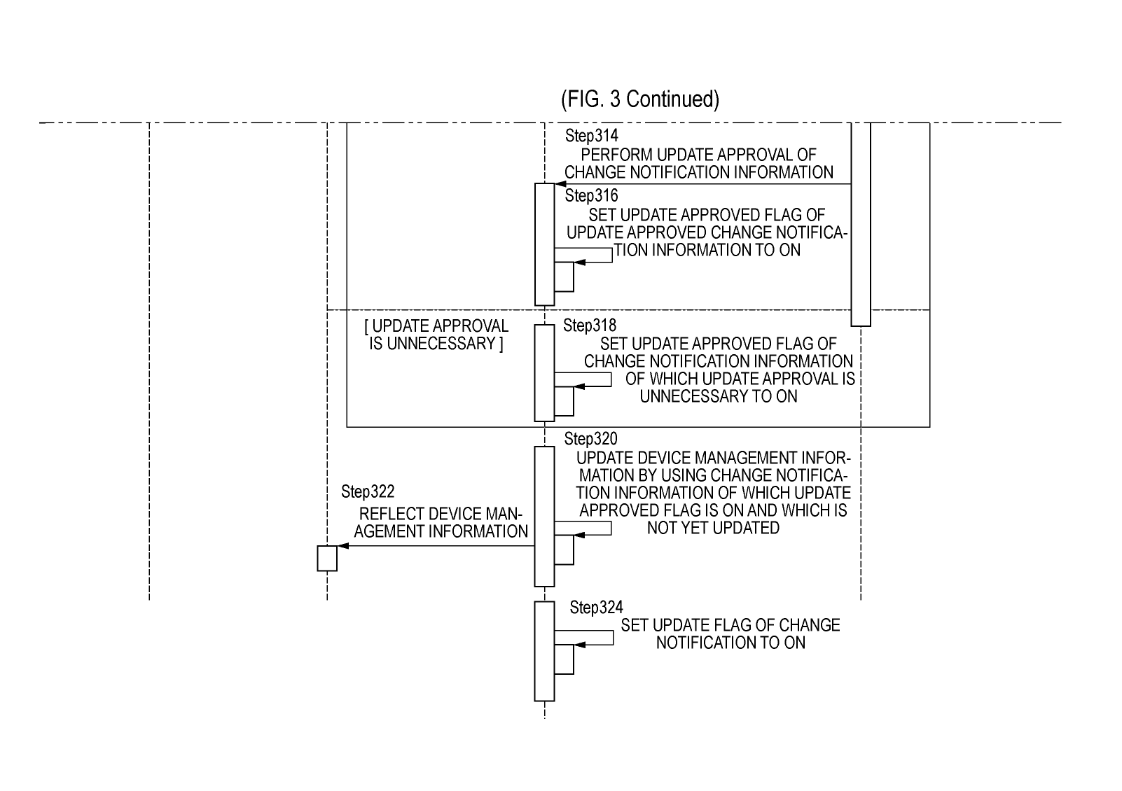

FIG. 3 is a flowchart illustrating an example of processes according to the exemplary embodiment.

In Step 302, the device manager 320 performs manipulation of changing the communication settings (IP address) with respect to the management object device 150. In addition, by the manipulation of the device manager 320, it can be set that, at the time of changing the communication settings, the update approval by the system administrator 310 is necessary.

In Step 304, the management object device 150 produces change notification information which is to be transmitted to the information processing apparatus 100.

The change notification information includes the following information.

Unique information (serial number) of the management object device 150

Communication settings (IP address) of the management object device 150

In addition, the change notification information may include the following information.

Main change approval flag (in the case of performing manipulation indicating that the update approval is necessary in Step 302),

Before-changed IP address, device name, model name, installation location, remark (information capable of identifying general data), and the like

In Step 306, the management object device 150 transmits the change notification information to the information processing apparatus 100.

In Step 308, the information processing apparatus 100 accumulates the change notification information in the notification information storage module 120.

In Step 310, the information processing apparatus 100 determines whether or not the update approval of the change notification information is necessary.

In a case where any one of the following conditions is matched, it is determined that the updating process for the change notification information is necessary.

(1) The communication settings (IP address) is matched with communication settings of device management information of another management object device 150.

(2) Device management information which is not yet updated exists in the device management information. Namely, this is a situation that, in a case where there is transmission from a management object device 150(1) in Step 306 in advance and there is an approval request to the system administrator 310, when there is transmission from another management object device 150(2) different from the management object device 150(1) in Step 306, the communication settings of the management object device 150(1) is not yet updated.

(3) The main change approval flag of the change notification information is ON. Namely, this is a case where manipulation that the update approval by the system administrator 310 is necessary at the time of changing the communication settings is performed by the device manager 320 in Step 302.

In a case where it is determined that the update approval is necessary in Step 310, processes of Steps 312 to 316 are performed, and in a case where it is determined that the update approval is unnecessary, a process of Step 318 is performed.

In addition, the information processing apparatus 100 may allow a result of combination of the change notification information and the device management information (determination result in Step 310) to be displayed on the management object device 150. Therefore, the device manager 320 can recognize whether the approval by the system administrator 310 is necessary in advance. In addition, the to-be-updated device management information can be checked in advance.

In Step 312, the information processing apparatus 100 allows the update approved flag of the change notification information to be OFF. Namely, this denotes that the update approval is not completed. The information processing apparatus 100 requests the system administrator 310 (system administrator terminal 210) to approve updating of the communication settings of the management object device 150.

In Step 314, the system administrator 310 approves the updating of the change notification information for the information processing apparatus 100 by using the system administrator terminal 210. Namely, the system administrator 310 checks the change notification information indicating that the update approved flag of the information processing apparatus 100 is OFF and approves the updating of the change notification information.

In addition, in a case where there is no replay from the system administrator terminal 210 and a predetermined time period (for example, five hours or the like) after the request for approval elapses, the determination process of Step 310 may be performed again. This is because there may occur a situation that the communication settings of another management object device 150 is updated and the update approval becomes unnecessary.

In Step 316, the information processing apparatus 100 allows the update approved flag of the update-approved change notification information to be ON. Namely, this denotes that the update approval is completed.

In Step 318, the information processing apparatus 100 allows the update approved flag of the change notification information indicating the update approval is unnecessary to be ON. Namely, this denotes an equivalent to a message indicating that the update approval is completed.

In Step 320, the information processing apparatus 100 updates the device management information by using the change notification information of which the update approved flag is ON and which is not yet updated.

In Step 322, the information processing apparatus 100 reflects the updated device management information on the management object device 150.

In Step 324, the information processing apparatus 100 sets an update flag of the change notification to ON. Namely, the reflected change notification information is changed to update-completed.

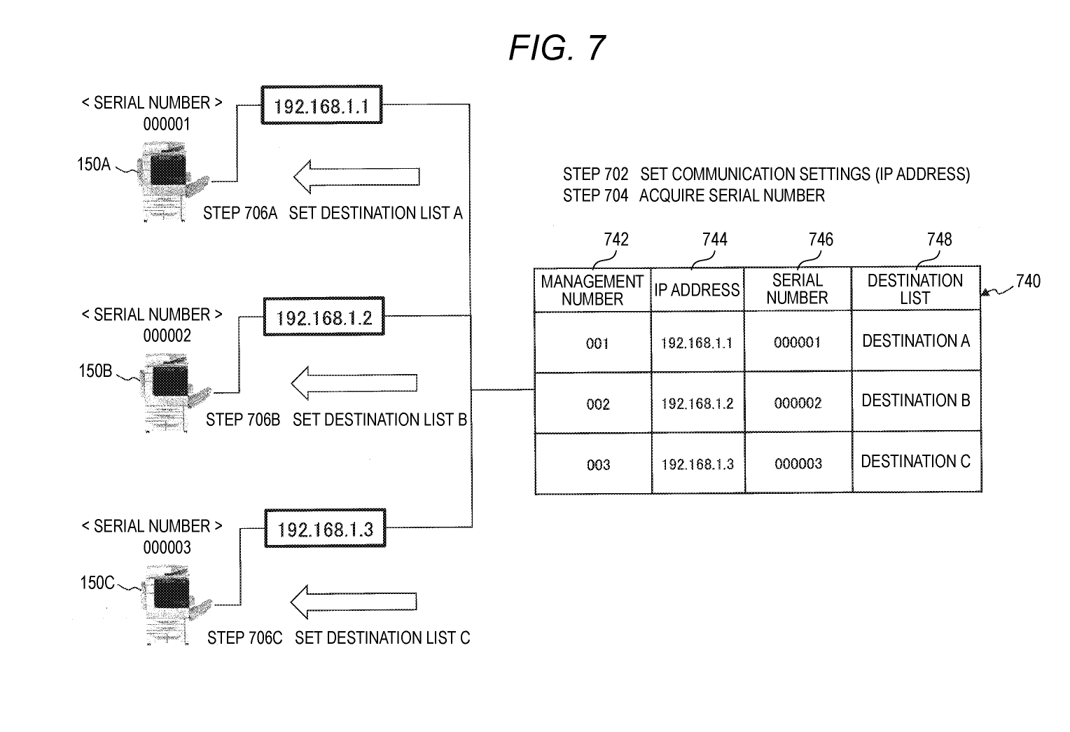

FIG. 7 is an explanation diagram illustrating an example of processes according to the exemplary embodiment. Herein, illustrated is an example of setting a destination list for each management object device 150 according to the information processing apparatus 100 and a device management information table 740.

The device management information table 740 has the same data structure as that of the device management information table 400 illustrated in the example of FIG. 4.

In Step 702 and Step 704, the information processing apparatus 100 acquires the IP address and the serial number from each management object device 150 to generate the device management information table 740.

In Step 706A, the information processing apparatus 100 performs setting of the destination list A with respect to the management object device 150A.

In Step 706B, the information processing apparatus 100 performs setting of the destination list B with respect to the management object device 150B.

In Step 706C, the information processing apparatus 100 performs setting of the destination list C with respect to the management object device 150C.

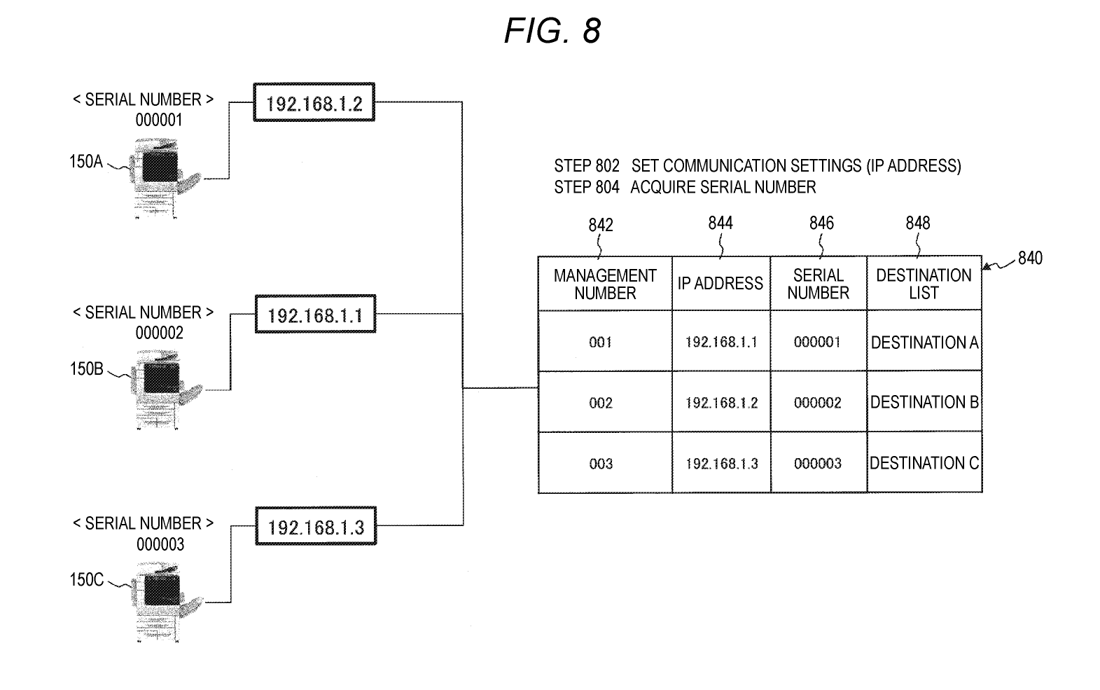

FIG. 8 is an explanation diagram illustrating an example of processes according to the exemplary embodiment.

A device management information table 840 has the same data structure as that of the device management information table 400 illustrated in the example of FIG. 4.

In Step 802 and Step 804, the information processing apparatus 100 acquires the IP address and the serial number from each management object device 150 to generate the device management information table 840.

Next, in a case where the device is replaced in a rearrangement manner from the state illustrated in the example of FIG. 7, that is, in a case where the management object device 150A and the management object device 150B are replaced and the IP address is replaced, the change notification information is transmitted from the previously changed device (management object device 150A) to the information processing apparatus 100.

If the exemplary embodiment is not used, in a case where the IP address is changed to a previously-registered IP address (in the example illustrated in FIG. 8, changed from “192.168.1.1” to “192.168.1.2”), it cannot be distinguished whether the notified information (IP address) is correct or the overlapped IP address is erroneously set.

In the exemplary embodiment, it is determined in Step 310 of the flowchart illustrated in the example of FIG. 3 that, since the IP addresses are overlapped, the update approval is necessary, and thus, the system administrator 310 is requested to perform the update approval.

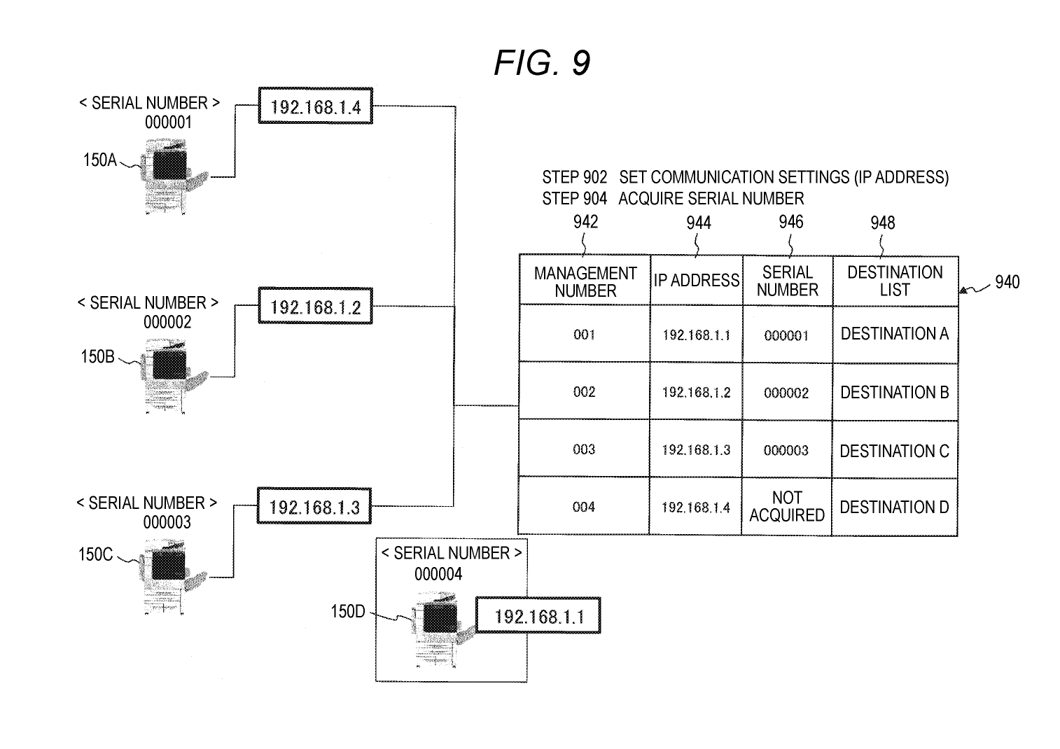

FIG. 9 is an explanation diagram illustrating an example of processes according to the exemplary embodiment.

A device management information table 940 has the same data structure as that of the device management information table 400 illustrated in the example of FIG. 4.

In Step 902 and Step 904, the information processing apparatus 100 acquires the IP address and the serial number of each management object device 150 to generate the device management information table 940. In a case where it is determined that there is a to-be-newly-installed management object device 150 (in the example of FIG. 9, a management object device 150D), before the new management object device 150 is connected to the communication line, the device management information is registered in the device management information table 940 in advance. Namely, the IP address is set in advance, and the destination list is also set. However, the serial number cannot be acquired if the management object device is not connected to the communication line.

The management object device 150D is newly installed from this state. However, at the timing when the new management object device 150D is introduced, the management object device 150D is desired to be used for replacement of the management object device 150A (namely, as the mainly used management object device 150, the management object device 150A is desired to be replaced with the management object device 150D). Therefore, in this case, the management object device 150D is set to the destination list A, and the management object device 150A is to the destination list D.

Herein, first, if the IP address of the management object device 150A is changed from an original one (changed from “192.168.1.1” to “192.168.1.4”), the IP addresses in the device management information table 940 overlap with each other.

In the exemplary embodiment, even in a case where replacement so-called billiard replacement occurs, it is determined in Step 310 of the flowchart illustrated in the example of FIG. 3 that, since the IP addresses overlap with each other, the update approval is necessary, and thus, the system administrator 310 is requested to perform the update approval.

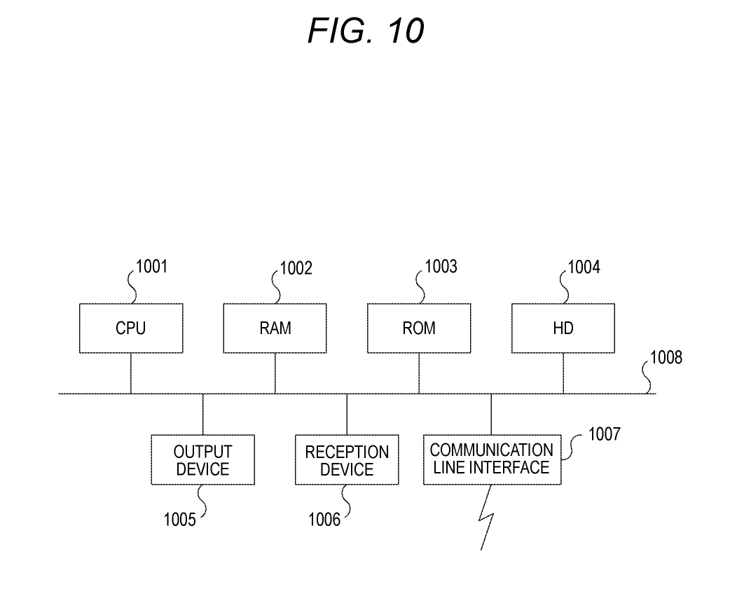

In addition, as illustrated in FIG. 10, in an exemplary embodiment, a hardware configuration of a computer (information processing apparatus 100, management object device 150) executing a program is a general computer, specifically, a personal computer, a computer which is to be a server, or the like. Namely, in a specific example, as a processing unit (calculation unit), a CPU 1001 is used, and as a storage device, a RAM 1002, a ROM 1003, and an HD 1004 are used. As the HD 1004, for example, a hard disk or an SSD (solid state drive) may be used. The computer is configured to include the CPU 1001 executing a program of the device information management module 105, the notification information management module 115, the device information reflection module 125, the information notification module 155, and the like, the RAM 1002 storing the program and data, the ROM 1003 storing a program and the like for activating the computer, the HD 1004 that is an auxiliary storage device (which may be a flash memory or the like) having the device information storage module 110, the notification information storage module 120, and the like, a reception device 1006 receiving data based on manipulation of the user for a keyboard, a mouse, a touch screen, a microphone, or the like, an output device 1005 such as a CRT, a liquid crystal display, or a speaker, a communication line interface 1007 such as a network interface card for connection to a communication network, and a bus 1008 for data exchange by connecting the above components. Plural computers may be connected to each other through a network.

Among the exemplary embodiments, the exemplary embodiment by the computer program is embodied by reading a computer program as software in a system as a hardware configuration and by cooperation of the software and hardware resources.

In addition, the hardware configuration illustrated in FIG. 10 is one configuration example. The exemplary embodiment is not limited to the configuration illustrated in FIG. 10, but any configuration capable of executing the modules described in the exemplary embodiment may be used. For example, a portion of the modules may be configured with dedicated hardware (for example, an application specific integrated circuit (ASIC) or the like), a portion of the modules may be in a form of being connected to a communication line in an external system, and furthermore, plural systems illustrated in FIG. 10 may be connected to each other through a communication line to cooperatively operate. In addition, particularly, the program may be incorporated into a mobile information communication device (including a mobile phone, a smartphone, a mobile device, a wearable computer, and the like), an electronic information appliance, a robot, a copying machine, a facsimile, a scanner, a printer, a multifunction device or the like as well as the personal computer.

In addition, a recording medium where the above-described program is stored may be provided, and in addition, the program may be provided through a communication unit. In this case, for example, with respect to the above-described program, a “computer-readable recording medium where a program is recorded” may be regarded as the invention.

The “computer-readable recording medium where a program is recorded” denotes a computer-readable recording medium where a program is recorded, which is used for installation and execution of the program and distribution of the program, and the like.

In addition, as a recording medium, for example, a digital versatile disk (DVD) such as a “DVD-R, a DVD-RW, and a DVD-RAM” in accordance with a standard regulated by a DVD forum, a “DVD+R, a DVD+RW, and the like” in accordance with a standard as a DVD+RW, a compact disk (CD) such as a read-only memory (CD-ROM), a CD recordable (CD-R), and a CD rewritable (CD-RW), a Blue-ray disk (Blu-ray (registered trademark) disc), a magneto-optical disk (MO), a flexible disk (FD), a magnetic tape, hard disk, a read-only memory (ROM), an electrically erasable programmable read-only memory (EEPROM (registered trademark)), a flash memory, a random access memory (RAM), an SD (secure digital) memory card, and the like may be included.

In addition, the entire of or a portion of the program may be recorded in the above-described recording medium, and the recording medium may be stored or distributed. In addition, the program may be transmitted through communication, for example, by using a transmission medium such as a wired network or a wireless communication network used for a local area network (LAN), a metropolitan area network (MAN), a wide area network (WAN), the internet, an intranet, a wired network, or an extranet, furthermore, a combination thereof, or the program carried on a carrier wave may be transmitted.

In addition, the program may be a portion of or the entire of another program, or the program with a separate program may be recorded in a recording medium. In addition, the program may be divided into plural recording media to be recorded. In addition, compression, encryption, and the like may be recorded in any form which can be restored.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a notification unit that, in response to receiving information indicating update of a communication address from a device, when the communication address indicated to be updated overlaps with a communication address of another device, notifies a message of the update to a manager; and
an updating unit that, in response to receiving approval about the notification by the notification unit, updates a value of a storage unit managing the communication address of the device with the communication address of the device indicated to be updated.

2. The information processing apparatus according to claim 1, wherein in response to receiving information indicating update of a communication address from a second device that is different from the device, when there is the notification by the notification unit but there is a non-updated device, the notification unit notifies a message indicating update of the communication address of the second device to the manager.

3. The information processing apparatus according to claim 1, wherein in a case where the information indicating the update of the communication address from the device includes information indicating that the approval of the manager is necessary, the notification unit notifies a message of the update to the manager.

4. The information processing apparatus according to claim 1, wherein in response to receiving the approval about the notification by the notification unit, the updating unit reflects the update of the communication address to the device.

5. A non-transitory computer-readable medium storing a program causing a computer to execute a process for information processing, the process comprising:
in response to receiving information indicating update of a communication address from a device, when the communication address to be updated overlaps with a communication address of another device, notifying a message of the update to a manager; and
in response to receiving approval about the notification, updating a value of a storage unit managing the communication address of the device with a communication address of the device.

6. An information processing method, comprising:
in response to receiving information indicating update of a communication address from a device, when the communication address to be updated overlaps with a communication address of another device, notifying a message of the update to a manager; and
in response to receiving approval about the notification, updating a value of a storage unit managing the communication address of the device with a communication address of the device.
